(19) United States
(12) Patent Application Publication
(10) Pub. No.: US 2012/0188285 A1
(43) Pub. Date: Jul. 26, 2012

(54) ENHANCED POINTING INTERFACE

(76) Inventors: Ram Friedlander, Zichron Yaacov (IL); Dan Ben Ishay, Zichron Yaacov (IL)

(21) Appl. No.: 13/499,117

(22) PCT Filed: Nov. 15, 2010
(86) PCT No.: PCT/IB2010/055169

§ 371 Date: Mar. 29, 2012

Related U.S. Application Data
(60) Provisional application No. 61/261,340, filed on Nov. 15, 2009.

(51) Int. Cl. G09G 5/00; G09G 5/08

(52) U.S. Cl. 345/660; 345/157

(57) ABSTRACT

An enhanced pointing interface associated with a user interface, e.g. a display, comprising a pointing interface arranged to detect locations, and possibly sizes and motions of pointing elements and a processing unit calculating a response, e.g. an interface area upon the display, and activate the response in relation to the detected parameters of the pointing elements. The enhanced pointing interface allows non-visual responses as well as visual ones, such as magnifying, diminishing and shifting (avoidance of hiding as well as panning) of the interface areas in response to location changes of the pointing elements, and further actions such as selection (thereby emulating a touch screen on a display which lacks touch capabilities) and repeated enhancement of parts of the interface areas.

### BACKGROUND

1. Technical Field

The present invention relates to the field of user interfaces, and more particularly, to an enhanced pointing interface.

2.Discussion of Related Art

Due to the expansion in the usage of pointing interfaces and of physically small communication and/or data processing devices, it becomes evermore complex to relate to small features of these devices.

The following patent documents relate to various user interfaces and interactive devices, yet are all incorporated herein by reference in their entirety: U.S. Patent Publication No. 2009/0058829 disclosing an apparatus and method for providing feedback for three-dimensional touchscreen; WIPO Publication No. 2008/111079 disclosing interactive devices; U.S. Patent Publication No. 2009/0021488 disclosing display and information input devices; WIPO Publication No. 2007/113828 disclosing user interface functionalities; and WIPO Publication No. 2007/029257 disclosing displays and information input devices.

### BRIEF SUMMARY

Embodiments of the present invention provide an enhanced pointing interface associated with a user interface, comprising: a pointing interface comprising at least one sensor arranged to detect a spatial location of at least one pointing element in respect to the pointing interface; and a processing unit arranged to receive the detected location of the pointing element; to calculate an interface area and an action therefrom according to specified preferences; and to control the user interface in respect to the interface area and the action.

Embodiments of the present invention provide an enhanced pointing interface associated with a display, comprising: a pointing interface comprising at least one sensor arranged to detect a location of at least one pointing element in respect to the pointing interface; and a processing unit arranged to receive the detected location of the pointing element; to calculate an interface area and an action from the detected location, according to specified preferences; and to control the display in respect to the interface area and the action, wherein the action is selected such as to enhance visibility of the interface area.

Accordingly, according to an aspect of the present invention, there is provided an enhanced pointing interface, wherein the action comprises a further measurement of the location such as to derivate at least one distance of the at least one pointing element and at least one projection area of the at least one pointing element on the display, and wherein the interface area and the action are calculated in respect to the projection area and the distance.

Accordingly, according to another aspect of the present invention, there is provided an enhanced pointing interface, wherein the at least one sensor comprises at least two sensors with differing measurement characteristics and different energy requirements, wherein a first sensor is arranged to detect an approach of the pointing element and conditionally activate thereupon a second sensor arranged to measure the location of the pointing element, wherein the conditional activation reduces an energy consumption of the enhanced pointing interface.

Accordingly, according to still another aspect of the present invention, there is provided an enhanced pointing interface, wherein the processing unit is further arranged to calculate a magnification of the interface area that is related to the distance, and the action further comprises magnifying the interface area by the magnification.

Accordingly, according to yet another aspect of the present invention, there is provided an enhanced pointing interface, wherein the action emulates, via the processing unit on the display, a touch on a touch-screen, upon detection of a location corresponding to specified criteria.

Embodiments of the present invention provide an enhanced pointing interface associated with a display, comprising: a pointing interface arranged to detect a three dimensional location of at least one pointing element in respect to the pointing interface, the three dimensional location comprising a respective projection area of each of the at least one pointing element upon the pointing interface and a respective distance of each of the at least one pointing element from the pointing interface; and a processing unit connected to the display and arranged to map the display upon the pointing interface, to receive the detected location of the pointing element and to calculate the projection area and the distance, wherein the processing unit is further arranged to calculate for each of the at least one pointing element, an interface area on the display in relation to the respective projection area and the respective distance, and to derive a magnification in relation to the distance, and wherein the processing unit is arranged to present on the display the interface area in the derived magnification, such that at least one part of the interface area that is congruent to and hidden by the projection area is visible as a result of the magnification.

Accordingly, according to an aspect of the present invention, there is provided an enhanced pointing interface, wherein the pointing interface is arranged to detect a crossing of the pointing element of the specified surface, that is at a distance larger than a specified threshold distance, and wherein the processing unit is arranged to activate a specified capability of the display upon the detection of the distance.

Accordingly, according to another aspect of the present invention, there is provided an enhanced pointing interface, wherein the display is congruent to the pointing interface.

Accordingly, according to still another aspect of the present invention, there is provided an enhanced pointing interface, wherein the at least one pointing element comprises a plurality of pointing elements, wherein the pointing interface is arranged to detect a three dimensional location of each pointing element independently of other pointing elements, and wherein the processing unit is arranged to calculate the interface area on the display in relation to the projection area and the distance, and to derive a magnification in relation to the distance for each pointing element independently of other pointing elements.

Embodiments of the present invention provide a method of enhancing a pointing interface, comprising: detecting a three dimensional location of a pointing element, the three dimensional location comprising a projection area of the pointing element upon the pointing interface and a distance of the pointing element from the pointing interface; presenting an interface area on a display that is mapped upon the pointing interface, the interface area mapped upon the projection area; and adjusting a size of the interface area in relation to the detected distance of the pointing element from the pointing interface.

Accordingly, according to an aspect of the present invention, there is provided a method, wherein the adjusting a size of the interface area further comprising panning the interface area on the display, diminishing the size of the interface area upon detecting a distancing of the pointing element from the interface area, and/or shifting the interface area on the display to a position adjacent to an original position of the interface area.

Accordingly, according to another aspect of the present invention, there is provided a method, further comprising measuring size and movements of the pointing element in respect to the pointing interface; and performing actions responsive to spatial relations of the measured movements of the pointing element with respect to the pointing interface.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIGS. 1, 2 and 3 are high level schematic illustrations of an enhanced pointing interface, according to some embodiments of the invention;

FIG. 4 is a high level schematic block diagram of an enhanced pointing interface, according to some embodiments of the invention;

FIGS. 5 and 6 are high level schematic illustrations of the operation of an enhanced pointing interface, according to some embodiments of the invention; and

FIGS. 7A and 7B are high level schematic flowcharts of a method of enhancing a pointing interface, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

For a better understanding of the invention, the usages of the following terms in the present disclosure are defined in a non-limiting manner:

The disclosure is applicable to any device capable of supporting a pointing interface as defined below, for example communication devices and data processing devices such as mobile phones, personal digital assistants, navigation devices, electronic games, electronic book readers and various computers.

The term “pointing element” as used herein in this application, is defined as any object or organ capable of inputting a spatial location to a pointing interface as defined below. Some examples are a finger, a pen, or a stylus. The term “pointing element” as used herein in this application, refers to an element that is not required to emit any information relating to its location.

The term “pointing interface” as used herein in this application, is defined as any interface which is detecting the X/Y/Z coordinates of the pointing element relative to the pointing interface. Examples are a touchpad, a touch screen and a camera.

The display may be congruent to and below, or congruent to and above the pointing interface. The display may be congruent to and in front, or congruent to and behind the pointing interface may be transparent. Some places we have above, some places we have below and some places we have congruent—maybe we should use one term in every place and describe it only once such as you did for “pointing element”. For example use “relational location” e.g. below, above congruent and separated”. The display and the pointing interface may be spatially separated and have any respective location. The pointing interface may be transparent such as to allow viewing the display therethrough.

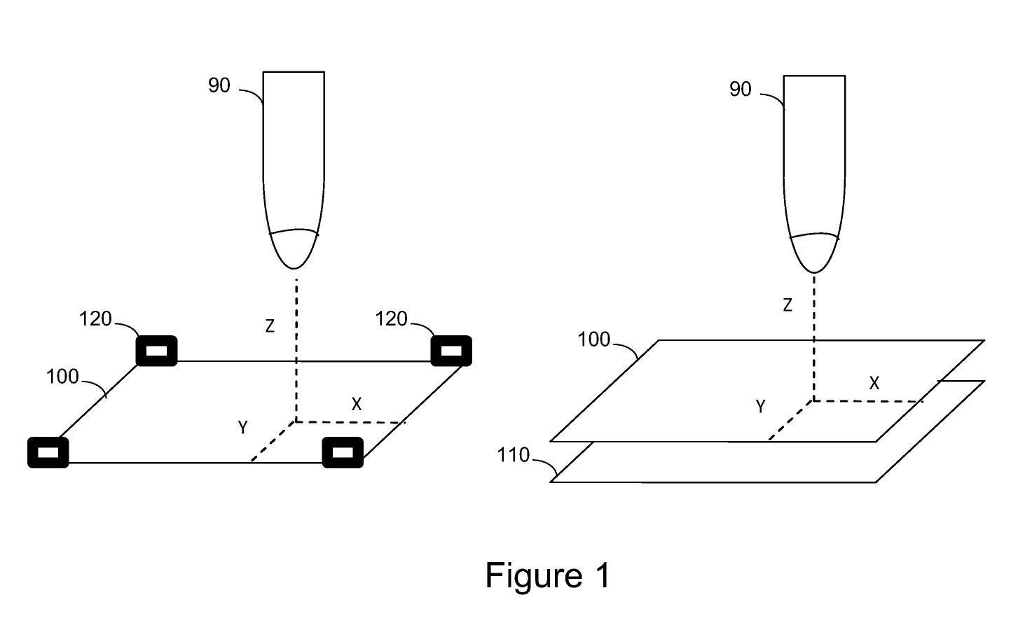

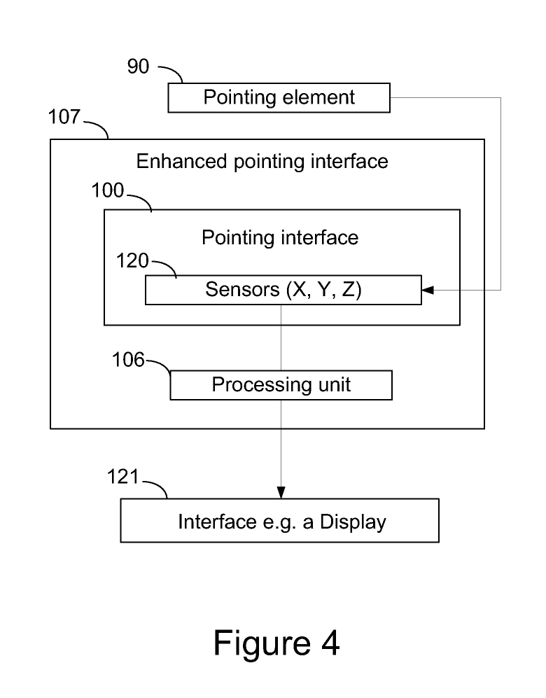

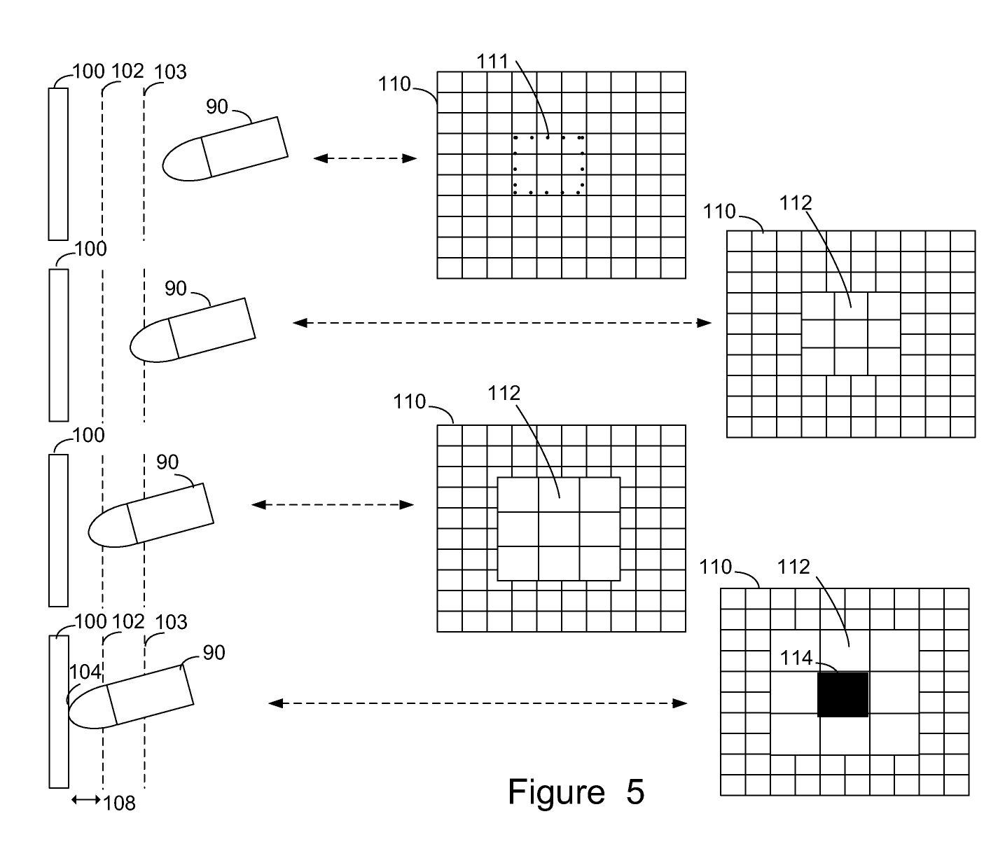

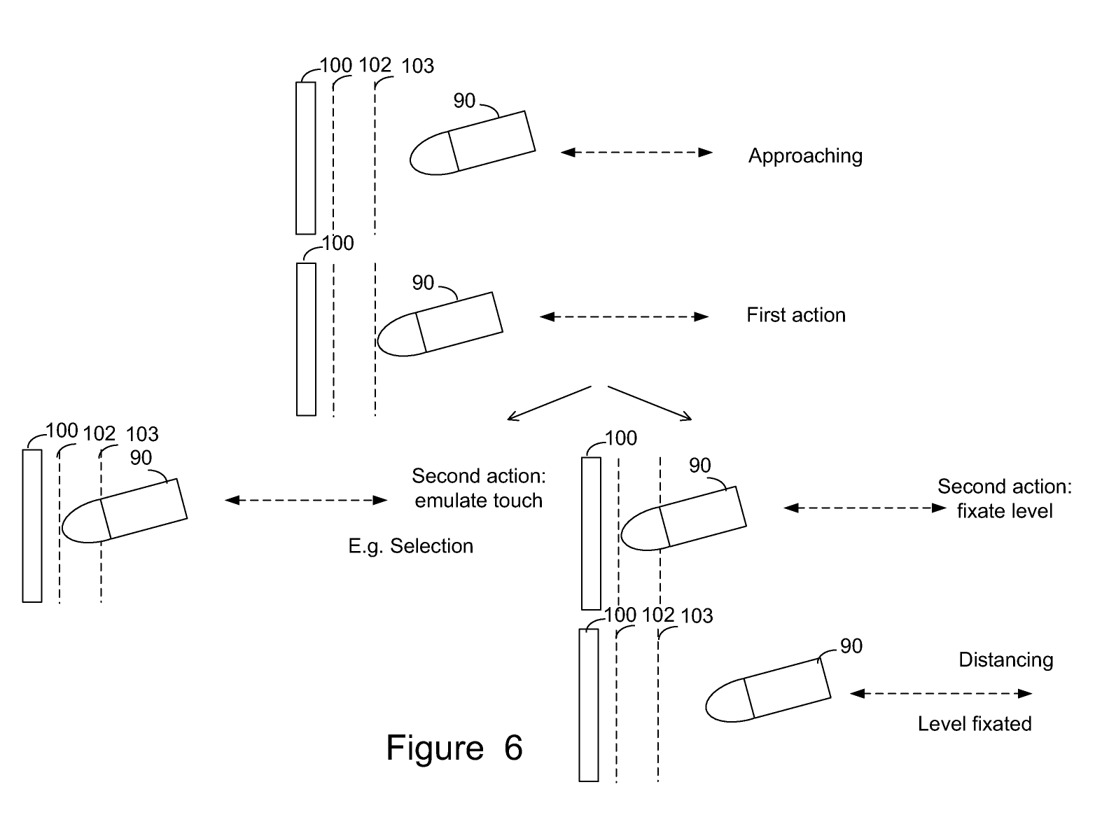

FIGS. 1, 2 and 3 are high level schematic illustrations of an enhanced pointing interface 107, according to some embodiments of the invention, FIG. 4 is a high level schematic block diagram of enhanced pointing interface 107, according to some embodiments of the invention, and FIGS. 5 and 6 are high level schematic illustrations of the operation of enhanced pointing interface 107, according to some embodiments of the invention.

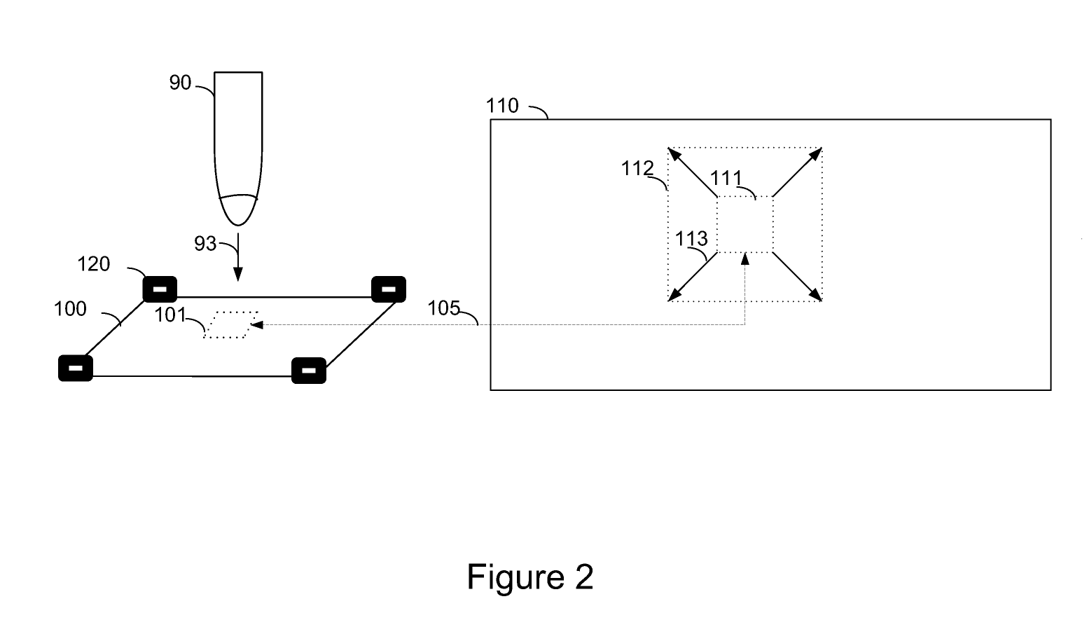

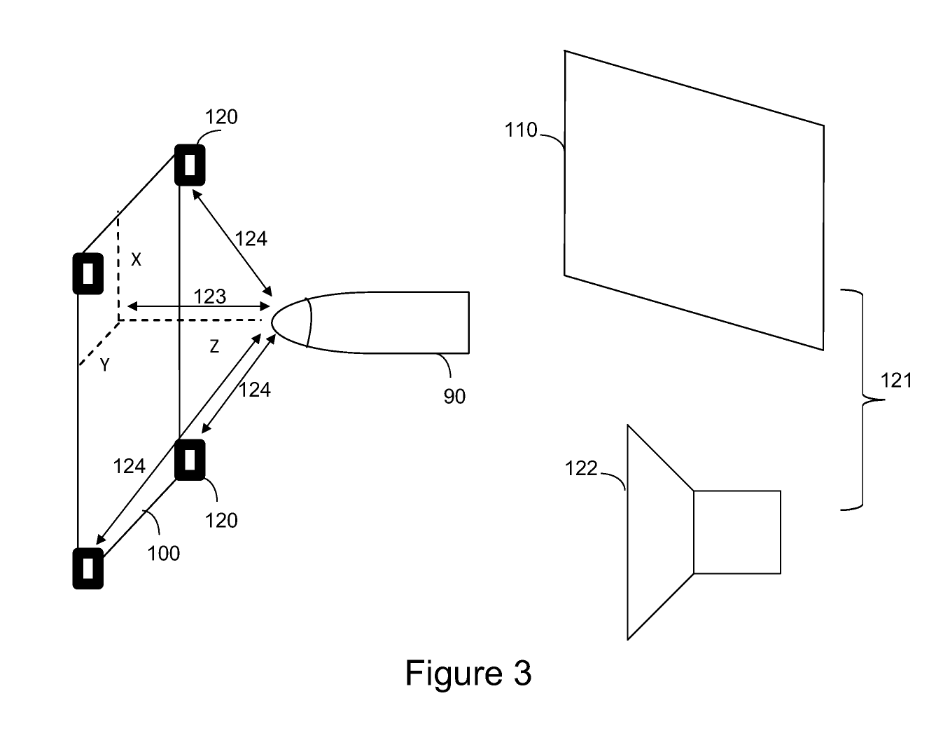

Enhanced pointing interface 107 comprises a pointing interface 100 and connected to an interface 121 (see FIGS. 3 and 4) e.g. a display 110 and mapped thereupon (mapping 105 is schematically shown in FIG. 2).

Pointing interface 100 is arranged to detect a three dimensional location (X, Y, Z or ranges thereof including object dimensions) of a pointing element 90 relative to the pointing interface 100. The three dimensional location comprises a projection area 101 of pointing element 90 upon pointing interface 100 (X and Y coordinates depend on the location and area size depends on the size of pointing element 90) and a distance (Z) (e.g., height) of pointing element 90 from pointing interface 100. In embodiments, the three dimensional location may comprise only a distance and a location of the center of projection area 101. The detection of the three dimensional location can be done in various existing technologies such as: infra-red lights, ultrasonic and more, by single or multiple sensors. The detection of the three dimensional location may be carried out in other methods and is not limited to the above mentioned methods.

In embodiment, pointing interface 100 is arranged to detect a spatial location of at least one pointing element 90 in respect to pointing interface 100, wherein the spatial location comprises a distance (123 or 124, see below and FIG. 3) of at least one pointing element 90 from either or both pointing interface 100 and user interface 121.

According to some embodiments of the invention, the three dimensional location comprises distance Z and an X, Y point location, e.g., of a center of projection area 101.

FIG. 3 illustrates variations of the detection of pointing element 90 by pointing interface 100 and of the results of the detection. Pointing interface 100 may measure either a distance 123 of pointing element 90 to pointing interface 100, distances 124 of pointing element 90 to sensors 120, spatial relations among pointing elements 90, location and/or movements of pointing elements 90, or a combination of distances 123, 124.

Interface 121 may be display 110 or may be a different interface such as an acoustic device 122 (e.g. a speaker announcing a data item related to the detected position of pointing element 90) or a controller interpreting the detected position as a specified command For example, certain distances of pointing element 90 from pointing interface 100 may correspond to specified selections or activations. The actions activated by pointing interface 100 may vary and be e.g. visual, acoustic, vibrational or another mechanical effect.

Actions may be activated responsive of various parameters, such as spatial location of pointing element 90 in respect to any axis (Z, X and Y, or another combination) and either in respect to pointing interface 100 and/or in respect to sensors 120, and/or in respect to spatial relations among pointing elements 90, location and/or movements of pointing elements 90, or a combination of distances 123, 124.

Furthermore, actions may be activated responsive of dynamical parameters of pointing element 90 such as its movement pattern, duration of stay at specified locations or other parameters.

FIG. 3 further illustrates the positional independence of pointing interface 100 and interface 121—pointing interface 100 may be separated spatially from interface 121.

FIG. 3 further illustrates the arbitrary orientation of pointing interface 100 which may be horizontal, vertical or inclined. Distances 123, 124 of pointing element 90 from pointing interface 100 may be measured in any relevant orientation.

In embodiments, pointing interface 100 is arranged to detect an approach of pointing element 90 towards pointing interface 100, or a threshold distance in respect thereto. In embodiments, pointing interface 100 is arranged to measure a size of pointing element 90 or categorize pointing element 90 as one of several object classes such as a finger, a pointer etc. In embodiments, pointing interface 100 is arranged to measure distance Z to pointing element 90 and not measure other location coordinates. A certain Z may initiate further measurements of X and Y. In embodiments, pointing interface 100 is arranged to measure a parameter relating to a size of pointing element 90 such as its cross section or projection upon pointing interface 100.

In embodiments, enhanced pointing interface 107 is associated with display 110, and comprises: pointing interface 100 comprising at least one sensor 120 arranged to detect a spatial location of at least one pointing element 90 in respect to pointing interface 100; and processing unit 106 arranged to receive the detected location of pointing elements 90; to calculate interface area 111 and an action therefrom according to specified preferences; and to control display 110 in respect to interface area 111 and the action, wherein the action is selected to enhance visibility of interface area 111. Actions may comprise a further measurement of the location such as to derivate at least one distance and at least one projection area 101 on display 110 of pointing elements 90, and wherein interface area 111 and the action are calculated in respect to projection area 101 and the distance.

Processing unit 106 may be implemented within enhanced pointing interface 107 or separately therefrom.

According to some embodiments, sensors 120 may comprise first level infra red sensors arranged to detect approaching pointing elements 90 and second level ultrasonic sensors arranged to measure geometric characteristics of pointing elements 90. Sensors 120 may comprise any other combination of first level and second level sensors such as both ultrasound, first level camera, first level ultrasound, second level infrared etc.

Processing unit 106 may be further arranged to calculate magnification 113 of interface area 111 that is related to the distance, and the action further comprises magnifying interface area 111 by magnification 113. Magnification 113 may increase with a decrease in the distance and wherein magnified interface area 112 may be diminished upon an increase in the distance.

Processing unit 106 may be further arranged to calculate magnification 113 that is related to the distance, and the action may further comprise magnifying content of interface area 111 by the magnification and within interface area 111. Details of the content may be magnified in relation to the distance in a “window” within interface area 111.

Magnification 113 may be carried out externally (e.g. by a switch, an application, a selection, by the user, orientation of display 110 or a voice command) or upon a specified action relating to pointing interface 100 itself, such as a dynamic movement of pointing element 90.

According to some embodiments, enhanced pointing interface 107 may be operating in two main modes: A viewing mode, in which magnification 113 and actions are selected to allow viewing of content such as letters or map details. For example content may be magnified or shifted in relation to the content structure in and around interface area 111. A writing mode, in which magnification 113 and actions are selected to facilitate writing, for example by magnifying characters in interface area 111, allowing character selection and continuously presenting the written message. In another example, a track on a map may be fed by sequentially magnifying successive parts or anticipated parts of the route.

The action may comprise panning, zooming in and zooming out of interface area 111, as well as selection among different possible interface areas 111 or subareas. Calculation of interface area 111 may comprise applying user defined preferences.

In embodiments, the location may be a three dimensional location comprising X, Y and Z coordinates, just a distance (Z), or even an indication of a range of distances. The location may also comprise the physical dimensions of pointing elements 90 and their projection on display 110, and even motion characteristics of pointing elements 90 such as speed and direction.

In embodiments, interface area 111 may be shifted from an original position of interface area 111 on display 110, such as to remove interface area 111 from projection area 101 on display 110 and thus enhance its visibility and avoid its hiding by projection area 101.

Sensors 120 may comprise at least two groups of sensors with differing measurement characteristics and different energy requirements, wherein a first group of sensor is arranged to detected an approach of pointing element 90 and conditionally activate thereupon a second group of sensors arranged to measure the location of pointing element 90, wherein the conditional activation reduces an energy consumption of enhanced pointing interface 107. For example, the first group of sensors may be ultrasonic sensors and the second group of sensors may be optical sensors (laser, optical or infrared).

The at least two groups may comprise sensors with differing measurement characteristics, for example different resolutions. Pointing interface 100 may receive data from one, some, or all groups of sensors according to specifications relating to energy saving, required resolutions and other operational parameters.

Processing unit 106 may be connected to display 110 and arranged to map display 110 upon pointing interface 100, to receive the detected location of pointing element 90 and to calculate projection area 101 and the distance. Processing unit 106 may be arranged to present on display 110 interface area 111 that is mapped to projection area 101 in a magnification 113 related to the distance (Z) of pointing element 90 from pointing interface 100. For example, as pointing element 90 lowers (93) toward pointing interface 100, interface area 111 is magnified (113) to a larger size 112.

According to some embodiments of the invention, interface area 111 or magnified interface area 112 may be moved in respect to its original location to avoid further hiding of parts thereof by pointing element 90.

According to some embodiments of the invention, determining interface area 111 and the magnification thereof may be carried out repeatedly upon nearing pointing element 90, in each step a part of magnified interface area 112 may be further magnified. Further more, diminution may be applied on magnified interface area 112 upon removing pointing element 90 away from pointing interface 100.

Magnification 113 may be determined in relation measured parameters of pointing element 90 such as size or motions. For example rapid nearing of pointing element 90 may determine a large magnification, while a slow distancing thereof may determine a small diminution.

Pointing interface 100 may comprise a touchpad or a touch screen with additional distance sensors 120, or other location sensors 120. Sensors 120 may be located according to their performance, possibly far apart of other elements of pointing interface 100. Enhanced pointing interface 107 may further comprise a processing unit 106 arranged to receive location measurements of pointing element 90 and calculate projection area 101, the distance (Z) of pointing element 90 and magnification 113 that results from the distance as well as from other parameters of the current application on display 110, relating e.g., to image and font sizes, environmental conditions (visibility, vibrations, movements), state of display 110 (e.g., tilt, rotation, space angle, vibrations) to learned user skill and disabilities etc. Processing unit 106 may then communicate to display 110 the location and size of interface area 111.

As an example, two surfaces 102, 103 may be defined above pointing interface 100, the crossing of which determines magnification 113. As illustrated in FIG. 5, crossing of surface 103 by pointing element 90 may magnify interface area 111 by a first magnification to magnified area 112 and further crossing of surface 102 by pointing element 90 may magnify interface area 111 by a second magnification to a larger magnified area 112. Crossing may occur during approach or distancing of pointing element 90 from display 110. Eventually, touching of pointing interface 100 by pointing element 90 at touch area 104 may enhance a part 114 of magnified area 112 or select a selectable element (such as an icon) in part 114. Thus, the magnification process may be carried out repeatedly, on ever smaller parts of the original interface area 111, or on details that are added upon magnification 113. Furthermore, magnification may be reversed (e.g., upon distancing pointing element 90 from pointing interface 100, resulting in diminution) and users may adjust the size of magnified area 112 by moving pointing element 90. For example, enhanced pointing interface 107 may be used to ease typing on a touch screen by enlarging letters and enabling selecting specific letters.

Crossing a specified surface may generate additional changes of displayed information, such as enhancement of specified element, presentation of additional information, presentation of different information as a function of the location of pointing element 90, rotation of the displayed information, selection etc.

According to some embodiments of the invention, a predefined surface such as surface 102 may be used to emulate a touch screen on pointing interface 100 which lacks touch-screen capabilities. Crossing the predefined surface by pointing element 90 may be used to indicate an emulated touching of pointing interface 100 and allow pointing interface 100 to react accordingly. Thus pointing interface 100 is virtually enhanced to function as a touch screen.

According to some embodiments of the invention, crossing a predefined area such as surface 103 with pointing element 90 may activate various functions of display 110 such as turning a backlight on, generating sounds, vibrations or other mechanical effects or turning distance sensors 120 or other sensors on. As an example, during night driving, moving pointing element 90 across surface 103 may generate driver cabin illumination. According to some embodiments of the invention, display 110 is congruent to and below pointing interface 100 and pointing interface 100 is transparent. Alternatively, pointing interface 100 and display 110 may be separate, for example, as implemented in laptops. In embodiments, display 110 may be congruent to and above pointing interface 100 and pointing interface 100 is arranged to measure the location of pointing element 90 in respect to display 110.

According to some embodiments of the invention, pointing interface 100 relates to virtual coordinates and measures the location of pointing element 90 in respect to these coordinates and in respect to a known position of display 110.

FIG. 6 illustrates alternative operation modes of pointing interface 100. In one example, surface 102 may be close but not touching pointing interface 100. Crossing surface 102 without actually touching pointing interface 100 may trigger an action similar to touching a touch pad. The “non-touching touch” may be used to allow users perform actions on user interface 121 without having to touch it, e.g. to prevent soiling of pointing interface 100 or to avoid infection from previous users. The distance of surface 102 from pointing interface 100 may be larger than the typical distance sensed by touchpad sensors, e.g. larger than few mm

FIG. 6 illustrates another mode of fixating a magnification, a state or an action triggered by crossing surface 102 after pointing element 90 has been removed from the corresponding location. Fixation may be carried out externally (e.g. by a switch, an application, a selection, by the user, or a voice command) or upon a specified action relating to pointing interface 100 itself, such as a dynamic movement of pointing element 90.

Pointing interface 100 may be turned “on” and “off' by, for example, by an external switch, sound or voice activation, an action or by an application that enable or disable the operation or functionality of sensors 120.

Pointing interface 100 may be arranged to detect and follow a plurality of pointing elements 90, distinguish them from each other, and/or measure only a specified sub group of pointing elements 90. The subgroup may be defined spatially (e.g. being within a specified region), dynamically (e.g. only moving pointing element 90) temporally (e.g. the first to be detected) individually (e.g. in relation to identification parameters) or by any other method. Pointing interface 100 may apply beam selection of pointing elements 90 to define specific area of interest and detect presence of pointing elements 90 only in the selected area of interest.

Examples for applying pointing interface 100 may range between e.g. enhancing readability of personal devices such as a GPS device or a cellular phone, through emulating touch screen functionality for non-touch screens, allowing a touchless touch to prevent soiling pointing interface 100 and avoid unwanted touching (e.g. on sanitary grounds) and even receiving commands by detecting and measuring movements of persons within a room relative to pointing interface 100. Pointing interface 100 may operate according to detected movements or according to detected locations of pointing elements 90 in respect to pointing interface 100, to sensors 120, or in respect to each other or other pointing elements 90.

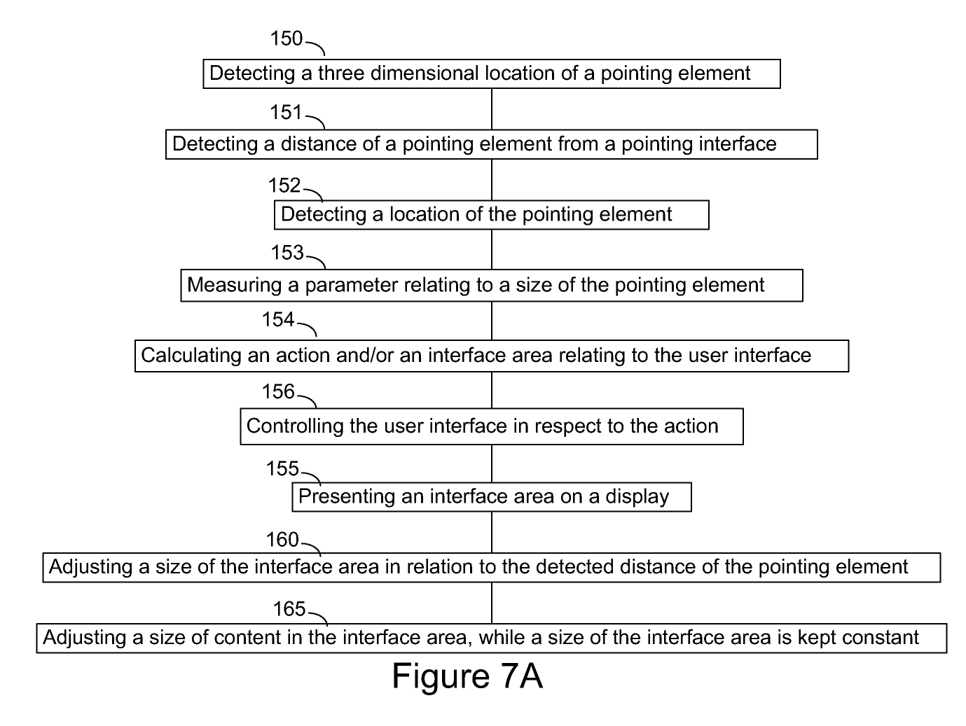

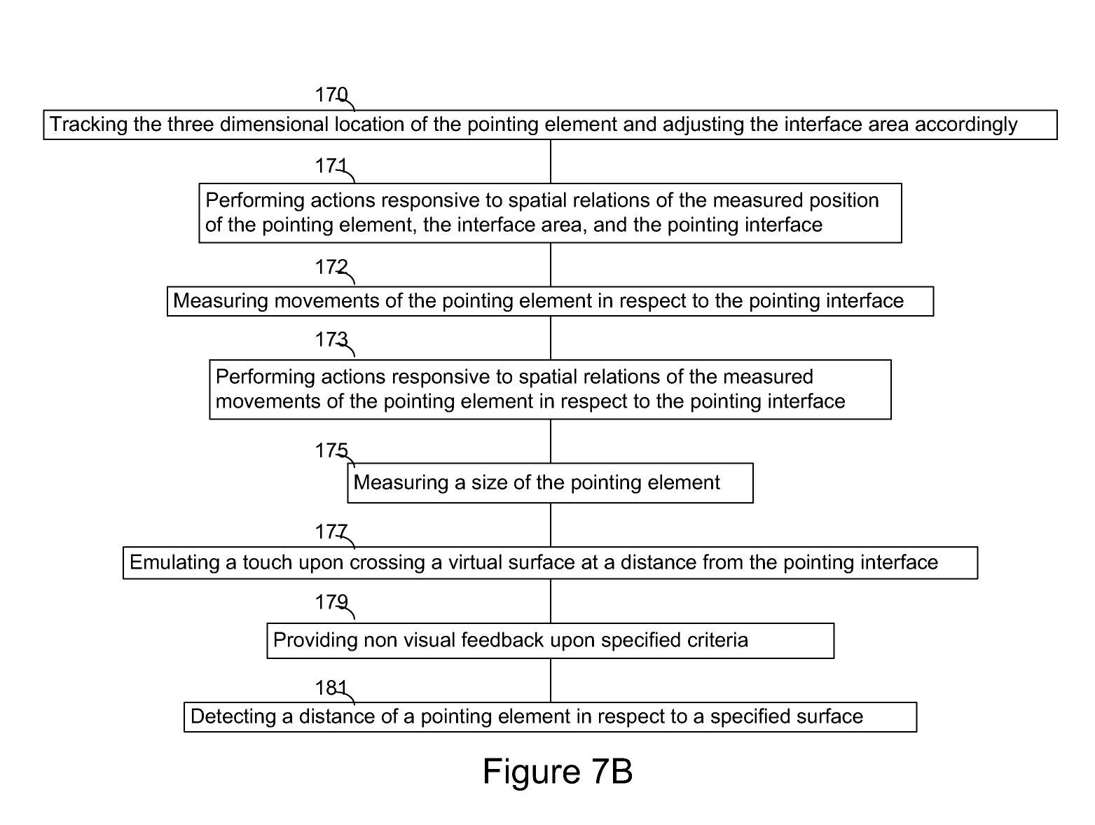

FIGS. 7A and 7B are high level schematic flowcharts of a method of enhancing a pointing interface, according to some embodiments of the invention. The method comprises the following stages: detecting a three dimensional location of a pointing element (stage 150), the three dimensional location comprising a projection area of the pointing element upon the pointing interface and a distance of the pointing element from the pointing interface; presenting an interface area on a display that is mapped upon the pointing interface (stage 155), where the interface area is mapped upon the projection area; and adjusting a size or other characteristics of the interface area in relation to the detected distance of the pointing element (stage 160) from the pointing interface, or adjusting a size of content in the interface area, while a size of the interface area is kept constant (stage 165).

Adjusting the size of the interface area may comprise displaying a portion of the information on the interface area or more generally on the display in an enhanced size. Characteristics of the interface area that may be adjusted (stage 160) comprise a size of content in the interface area, while a size of the interface area is kept constant.

Detecting the three dimensional location (stage 150), may comprise detecting a nearing or a distancing of the pointing element to or from the pointing interface, as well as partial parameters of the three dimensional location such as a distance.

According to some embodiments of the invention, the method may further comprise tracking the three dimensional location of the pointing element and adjusting the interface area accordingly (stage 170).

According to some embodiments of the invention, detecting a three dimensional location of a pointing element (stage 150) may comprise detecting a distance (Z) (stage 151) and consequently detecting a location (X,Y) (stage 152). Detecting the distance (Z) (stage 151) may then be used as an initiator for the further stages, allowing the implementation of power saving features and other advantages such as cost saving. Detecting the distance can be performed with multi-level sensors which may differ by sensitivity level, maximum distance detection, power consumption and other parameters. In embodiments, detecting a three dimensional location of a pointing element (stage 150) may comprise measuring a parameter relating to a size of the pointing element (stage 153) such as its cross section or projection upon the pointing interface.

According to some embodiments of the invention, the magnification may depend on the distance (e.g., height, Z) of the pointing element from the pointing interface and withdrawing the pointing element may decrease the magnification. There may be a threshold distance above which the interface area is not magnified. Upon distancing the pointing element from the display, the method may comprise diminishing the interface area.

According to some embodiments of the invention, actual selection may be carried out by touching the pointing interface or by nearing the pointing element to the pointing interface to a distance below a predefined threshold (thus functionalizing the pointing interface as a virtual touch screen).

According to some embodiments of the invention, confirmation of selection may be carried out by various feedback methods, such as a mechanical effect, a sound, a beep, a change of background color of the selected item, by further magnification of the selection, or by alternative ways.

According to some embodiments of the invention, the method may comprise performing actions responsive to spatial relations of the measured position of the pointing element, the interface area, and the pointing interface (stage 171). Such actions may comprise selection and confirmation.

According to some embodiments of the invention, the method may comprise measuring movements of the pointing element in respect to the pointing interface (stage 172) and performing actions responsive to spatial relations of the measured movements of the pointing element and the pointing interface (stage 173).

According to some embodiments of the invention, adjusting a size of the interface area (stage 160) may further comprise panning the interface area on the display; diminishing the size of the interface area upon detecting a distancing of the pointing element from the interface area; and/or shifting the interface area on the display to a position adjacent to an original position of the interface area.

According to some embodiments of the invention, the method may further comprise measuring a size of the pointing element (stage 175) and using the size to calculate the interface area and actions relating thereto.

The method may comprise detecting a spatial location of at least one pointing element in respect to the pointing interface, wherein the spatial location comprises a distance of the at least one pointing element from at least one of: the pointing interface; and a user interface, a sensor and another pointing element, and calculating an action relating to the user interface from the detected location according to specified preferences; and controlling the user interface in respect to the action.

The method may further comprise the following stages (FIG. 7A): Calculating an action and/or an interface area relating to the user interface (stage 154) and controlling the user interface in respect to the action (stage 156). The method may further comprise the following stages (FIG. 7B): Detecting a distance of a pointing element in respect to a specified surface (stage 181), and emulating a touch upon crossing a specified virtual surface at a specified distance from the pointing interface (stage 177). The method may further comprise providing non visual feedback upon specified criteria (stage 179).

According to some embodiments of the invention, magnification 113 allows viewing elements in projection area 101 although it is concealed from the user, due to magnifying and spreading of the concealed area by magnification 113. A shift of interface area 111 may be applied to further enhance the visibility of hidden details.

According to some embodiments of the invention, several pointing elements 90 may be applied to pointing interface 100 and each, some or one of pointing elements 90 may apply the magnification process described above. Pointing elements 90 may or may not be related to each other. Interaction among pointing elements 90 may be implemented at processing unit 106, such as an enhancement of magnification 113 in relation to the number of pointing elements 90 and their locations. Pointing interface 100 may be arranged to detect a relative distance of at least two of pointing elements 90, and processing unit 106 may be arranged to calculate an action associated with the relative distance between pointing elements 90.

According to some embodiments of the invention, magnification 113 may be carried out in a single step, multiple steps, or in a graduated manner (linear or non-linear). Magnification function may be predefined or determined by or according to the user, the manufacturer definition, the application and/or more. The magnification factor may be predefined or determined by or according to the user, the manufacturer definition, the application, the orientation of the information on the screen (pointing interface 100) and/or more. A maximal magnification 113 may be likewise predefined or determined by or according to the user, the manufacturer definition, the application, the orientation of the information on the screen and more. Magnification 113 may be applied to pre-selected applications only, which may be predefined or determined by or according to the user. Magnification 113 may be carried out in various methods that may be predefined or determined by or according to the user, or applications. For example, the area around magnified area 112 may be hidden, displayed or magnified, and magnified area 112 may be opaque (non-transparent) or partly transparent. Magnification 113 may be enabled or disabled per application, or rotation of the device, or selection of the user or in any other method. Magnified area 112 may be rectangle, circle, oval or of any other geometric shape. Magnification area 112 may comprise a small section of the information or the entire information on display 110 or any other portion of the information.

According to some embodiments of the invention, processing unit 106 may be arranged to calculate magnification 113 in further relation to characteristics of an image that is presented concurrently on display 110. For example, the characteristics of the image may comprise a font size, and processing unit 106 may be arranged to calculate magnification 113 in relation to at least one specified font size. Processing unit 106 may be arranged to calculate magnification 113 in further relation to concurrent environmental conditions such light and vibrations and user characteristics such as optical limitations and preferences.

According to some embodiments of the invention, the three dimensional location of pointing element 90 may comprise a distance from a specified surface. Pointing interface 100 may be arranged to detect a distance of pointing element 90 from the specified surface that is larger than a specified threshold distance 108, and processing unit 106 may be arranged to activate a specified capability of display 110 upon the detection of the specified distance that is larger than specified threshold distance 108. For example, processing unit may be arranged to allow selecting an element such as an object or an area on display 110 upon the detection of the specified distance, thereby emulating a touch on a user interface or a non-touch screen display 110.

According to some embodiments of the invention, processing unit 106 may be arranged to activate features of display 110 according to a specified detected three dimensional location of pointing element 90 such as a specified range, a specified location, specified motions etc. For example, a backlight of display 110 may be activated upon moving pointing element 90 in front of display 110.

According to some embodiments of the invention, pointing interface 100 may be arranged to detect a crossing of pointing element 90 of at least one specified surface, and processing unit 106 may be arranged to control display 110 in relation to the detected crossing. For example, processing unit 106 may derive magnification 113 in relation to the detected crossing and to the crossed specified surface. Processing unit 106 may further be arranged to change the derived magnification upon detection of changes in the distance and control display 110 substantially immediately thereupon.

Magnification 113 may be linear or otherwise specified. The three dimensional location may be used to control real-time zooming and panning of displayed information as well as allow the user a flexible and immediate control of magnification 113. Advantageously, the invention allows presenting display information hidden by pointing element 90, or too small to be read, applying magnification 113 in respect to the displayed content. Such content may comprise letters and their font size, map details, icons, image details etc.

According to some embodiments of the invention, enhanced pointing interface 107 may have several modes of operation relating to different tasks. For example, a “viewing” configuration may differ from a “writing” configuration, and “viewing” configuration may be further separated to “text viewing” and “map viewing”. The operation modes may be selected by the user or may be automatically identified from the context, or from specified locations or movements of pointing element 90.

According to some embodiments of the invention, sensors 120 may have several power consumption levels which may be managed by processing unit 106 power consumption and costs. For example, the first level of detection could be done by low power consumption sensor or sensors 120, and only when such detectors detects that pointing element 90 is close to the pointing interface 100, then another set of sensors which consume higher power consumption is activated for more accurate higher resolution sensing and/or for more information such as X,Y axes.

Advantageously, the disclosed devices and methods allow users to avoid typing or selection mistakes when using the enhanced pointing interface. This advantage is achieved by magnifying the area of interest (e.g., interface area 111) to a level that the user can easily perform the typing or selection without mistakes. The disclosed devices and methods further allow the user to read extremely small size information displayed on hand-held devices, while using only his finger (as pointing element 90) or any other pointing element 90, and to easily adjust the size of the data to his personal magnification needs.

Advantageously, the disclosed devices and methods further: enable selection of characters/keypad of extremely-small-size avoiding incorrect selection; enable the user to easily refine the selection of characters/keypad before the actual selection; enable observation or viewing of small-size details without the need to perform tedious consecutive operations of zoom-in and zoom-out; enable people with sight limitation of viewing extremely small-size data to read such information which was not readable for them before; lower the power consumption of hand-held devices by shortening the time it takes to type each character and/or sentence; and lower the power consumption of hand-held devices by using set of proximity / location detectors with different characteristics of power consumption and accuracy.

Advantageously, the disclosed devices and methods overcome problems and difficulties in viewing, selecting and typing information on a screen. Such problems may occur due to the physical size of the displayed information, which may be too small and therefore difficult to read. This difficulty is becoming more critical in small handheld applications such as: mobile (cellular) phones; MID (Mobile Internet Devices); PDAs (Personal Digital Assistants); PND (Personal Navigation Devices); PNP (Personal Media Players), GPS (Global Positioning Systems); Portable Gaming devices; Laptops, Tablet PC's and netbooks; Car Entertainment Systems and Electronic Reader Books (such as Kindle). The user may want to select specific location from the displayed information, such as specific character in the case of typing, or specific location on a map or drawing or image for “zoom in” or drag functions, or for any other selection purpose. The user may also want just to magnify (enlarge) specific area of the displayed information to improve readability of the information. When the user is trying to select the area of interest (e.g., interface area 111), pointing element 90 used for the selection may hide the area of interest within projection area 101 of pointing element 90. This may result with incorrect selection such as mistyping. When the user is trying to select the area of interest, if pointing element 90 is much larger than the area of interest, an incorrect selection may occur due to the low selection resolution. In some embodiments which are showing the actual selection only after pointing element 90 touches pointing interface 100, if the user, while searching for the right character to select, decides to abort (cancel) the selection operation—then the user needs to drag pointing element 90 to an area on pointing interface 100, where there is nothing to select, and then detach pointing element 90 from pointing interface 100. If the entire area of pointing interface 100 includes selection area, then the user cannot abort the selection operation and has to type wrong character (followed by deletion of this character). The process that the users are using today in order to type properly on pointing interface 100 is much more complex than the disclosed solution. While existing solutions require: touching the keypad (as close as possible to the area of interest); verifying that the correct character/key is pressed; if the wrong character/key is pressed—moving the finger to correct the selection; repeat the above mentioned steps until satisfied; and selecting by receding the finger, the disclosed solution requires only: approaching a finger (as an example of pointing element 90) to the requested character/key (the information is automatically magnified to support proper selection); and selecting by actual physical touch (FIG. 5, at touch area 104) or by proximity within predefined threshold (above specified threshold distance 108).

Regarding problems while viewing small size information on the screen: In today solutions, while magnifying the information, the entire screen is magnified and the user can see only small portion of the information. Then the user needs to pan the information on the screen or “zoom-out” to select the interesting part of the information. In the disclosed invention, one embodiment is that only a portion of interface area 111 is enlarged. This enables the user to understand the whole concept of the information on the screen including the one which is not magnified, and the position of the enlarged area relative to the entire information of the screen.

The disclosed invention comprises several features and elements that prior art does not include. For example, prior art patent documents do not assume that the size of the finger is a problem when the user wants to type on touch-screen; do not describe the problem that the pointing element (such as a finger) may conceal an important portion of the input device; do not distinguish among close neighboring characters; enlarge single characters and not a region; and require selection in order to read small-size text; and do not use multiple pointing elements. Furthermore, prior art patent documents do not describe the option to use several levels of sensors for power consumption and cost saving; do not describe the method to select item by proximity without physical touch; and do not describe linear magnification of the presented information. Finally, prior art patent documents do not describe real-time “zoom-in, zoom-out & pan” of the displayed information as a function of the distance and “location” of pointing element; and do not describe full flexibility and immediate control of the user on the magnification factor (no need to repeat magnification and panning steps). All these features are included as embodiments of the disclosed invention.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. An enhanced pointing interface associated with a user interface, comprising:
a pointing interface comprising at least one sensor arranged to detect a spatial location of at least one pointing element in respect to the pointing interface, wherein the spatial location comprises a distance of the at least one pointing element from at least one of: the pointing interface; and the user interface, and
a processing unit arranged to receive the detected location of the pointing element; to calculate an interface area and an action therefrom according to specified preferences; and to control the user interface in respect to the interface area and the action.

2. The enhanced pointing interface of claim 1, wherein the user interface is a display and the action is selected to enhance visibility of the interface area.

3. The enhanced pointing interface of claim 2, wherein the action comprises a further measurement of the spatial location such as to derivate at least one distance of the at least one pointing element and at least one projection area of the at least one pointing element on the interface area, and wherein the interface area and the action are calculated in respect to the projection area and the distance.

4. The enhanced pointing interface of claim 3, wherein the processing unit is further arranged to calculate a magnification of the interface area that is related to the distance, and the action further comprises magnifying the interface area by the magnification.

5. The enhanced pointing interface of claim 4, wherein the processing unit is arranged to calculate the magnification in further relation to characteristics of an image that is presented concurrently on the display.

6. The enhanced pointing interface of claim 5, wherein the characteristics of the image comprise a font size, and wherein the processing unit is arranged to calculate the magnification in relation to at least one specified font size.

7. The enhanced pointing interface of claim 4, wherein the processing unit is arranged to calculate the magnification in further relation to concurrent environmental conditions.

8. The enhanced pointing interface of claim 4, wherein the processing unit is arranged to calculate the magnification in further relation to user characteristics.

9. The enhanced pointing interface of claim 4, wherein the processing unit is arranged to calculate the magnification in further relation to a current application that is presented on the display.

10. The enhanced pointing interface of claim 4, wherein the processing unit is arranged to calculate the magnification in further relation to a state of the display.

11. The enhanced pointing interface of claim 4, wherein the magnification increases with a decrease in the distance and wherein the magnified interface area is diminished upon an increase in the distance.

12. The enhanced pointing interface of claim 3, wherein the interface area is shifted from an original position of the interface area on the display, such as to remove the interface area from the projection area on the pointing interface.

13. The enhanced pointing interface of claim 3, wherein the processing unit is further arranged to calculate a magnification that is related to the distance, and the action further comprises magnifying content of the interface area by the magnification and within the interface area.

14. The enhanced pointing interface of claim 1, wherein the three dimensional location of the at least one pointing element comprises a distance of the pointing element from a specified surface.

15. The enhanced pointing interface of claim 14, wherein the pointing interface is arranged to detect a crossing of the pointing element of the specified surface, that is at a distance larger than a specified distance, and wherein the processing unit is arranged to activate a specified capability of the user interface upon the detection of the distance.

16. The enhanced pointing interface of claim 15, wherein the user interface is a display and wherein the processing unit is further arranged to allow selecting an element on the display upon the detection of the specified distance.

17. The enhanced pointing interface of claim 1, wherein the three dimensional location of the at least one pointing element comprises a distance of the pointing element from the at least one sensor.

18. The enhanced pointing interface of claim 1, wherein the location is a three dimensional location comprising X, Y and Z coordinates of the at least one pointing element.

19. The enhanced pointing interface of claim 1, wherein the at least one sensor comprises a plurality of sensors with differing measurement characteristics and different energy requirements, wherein at least one first sensor is arranged to detected an approach of the pointing element and conditionally activate thereupon at least one second sensor arranged to measure the location of the pointing element, wherein the conditional activation reduces an energy consumption of the enhanced pointing interface.

20. The enhanced pointing interface of claim 19, wherein the at least one first sensor is an infra red sensor and the at least one second sensor is an ultrasonic sensor.

21. The enhanced pointing interface of claim 19, wherein the at least one first sensor is an ultrasonic sensor and the at least one second sensor is an ultrasonic sensor.

22. The enhanced pointing interface of claim 1, wherein the pointing interface is arranged to detect a motion of the at least one pointing element and change the interface area in respect to motion characteristics and specified preferences.

23. The enhanced pointing interface of claim 1, wherein the action emulates a touch on a user interface, upon detection of a location corresponding to specified criteria.

24. The enhanced pointing interface of claim 1, wherein the at least one sensor is at least one of: an infra red sensor; and an ultrasonic sensor.

25. The enhanced pointing interface of claim 2, wherein the processing unit is arranged to activate at least one of: a backlight of the display; an audio signal; a visual signal and a mechanical signal, when the detected three dimensional location of the pointing element is within a specified range.

26. The enhanced pointing interface of claim 1, wherein the processing unit is arranged to activate at least one of: an audio signal; a visual signal and a mechanical signal, according to a specified detected three dimensional location of the pointing element.

27. The enhanced pointing interface of claim 2, wherein the display is congruent to the pointing interface.

28. The enhanced pointing interface of claim 2, wherein the display and the pointing interface are spatially separated.

29. The enhanced pointing interface of claim 1, wherein the at least one pointing element comprises a plurality of pointing elements, wherein the pointing interface is arranged to detect a three dimensional location of each pointing element independently of other pointing elements, and wherein the processing unit is arranged to calculate an action associated with at least one of the three dimensional locations of the pointing elements.

30. The enhanced pointing interface of claim 29, wherein the user interface is a display, and wherein the processing unit is arranged to calculate the interface area on the display in relation to the projection area and the distance, and to derive a magnification in relation to the distance for each pointing element independently of other pointing elements.

31. The enhanced pointing interface of claim 1, wherein the pointing interface is arranged to detect a crossing of the at least one pointing element of at least one specified surface, and wherein the processing unit is arranged to control the user interface in relation to the detected crossing.

32. The enhanced pointing interface of claim 31, wherein the user interface is a display, and wherein the processing unit is arranged to derive the magnification in relation to the detected crossing and to the crossed specified surface.

33. The enhanced pointing interface of claim 1, wherein the pointing interface is activated by at least one of: an application; a switch; a selection; and a voice command.

34. The enhanced pointing interface of claim 1, wherein the at least one pointing element comprises a plurality of pointing elements, wherein the pointing interface is arranged to detect a relative distance of at least two of the pointing elements, and wherein the processing unit is arranged to calculate an action associated with the relative distance between the pointing elements.

35. The enhanced pointing interface of claim 34, wherein the processing unit is further arranged to change the derived magnification upon detection of changes in the distance and control the display substantially immediately thereupon.

36. A method of enhancing a pointing interface, comprising:
detecting a spatial location of at least one pointing element in respect to the pointing interface, wherein the spatial location comprises a distance of the at least one pointing element from at least one of: the pointing interface; at least one sensor; and a user interface, and
calculating an action relating to the user interface from the detected location according to specified preferences; and
controlling the user interface in respect to the action.

37. The method of claim 36, wherein the user interface comprises a display and the calculating comprises calculating an interface area on the display, the method further comprising:
detecting a projection area of the at least one pointing element upon the pointing interface;
presenting the interface area on the display that is mapped upon the pointing interface, the interface area mapped upon the projection area; and
adjusting characteristics of the interface area in relation to the detected distance.

38. The method of claim 37, wherein the characteristics of the interface area comprise a size of the interface area.

39. The method of claim 37, wherein the characteristics of the interface area comprise a size of content in the interface area, while a size of the interface area is kept constant.

40. The method of claim 37, further comprising calculating a magnification of the interface area that is related to the distance, and the action further comprises magnifying the interface area by the magnification.

41. The method of claim 40, wherein the magnification is determined externally by at least one of: a switch, an application, a selection, by the user, a voice command, a dynamic movement, and upon a specified action relating to the pointing interface.

42. The method of claim 37, wherein the display is congruent to and below the pointing interface and wherein the two dimensional interface is transparent, and further comprising presenting the interface area upon the display.

43. The method of claim 37, wherein the display is congruent to the pointing interface, and the method further comprising presenting the interface area upon the display.

44. The method of claim 37, further comprising tracking the spatial location of the at least one pointing element and adjusting the interface area accordingly.

45. The method of claim 36, wherein the detecting a spatial location of a at least one pointing element comprises detecting a distance of at least one pointing element from pointing interface, and using the distance as an initiator for further actions, thereby implementing power saving features.

46. The method of claim 36, wherein the detecting a spatial location of a at least one pointing element comprises detecting a distance of the at least one pointing element in respect to a specified surface and the action is activated upon detection of a crossing the specified surface with the at least one pointing element.

47. The method of claim 37, wherein the detecting a spatial location of a at least one pointing element comprises detecting a distance of the at least one pointing element in respect to a specified surface and emulating a touch screen on the display in respect to the specified surface, such that crossing the specified surface with the at least one pointing element simulated touching the touch screen.

48. The method of claim 37, wherein the adjusting characteristics of the interface area further comprises panning the interface area on the display.

49. The method of claim 37, wherein the adjusting characteristics of the interface area further comprises diminishing the size of the magnified interface area upon detecting a distancing of the at least one pointing element from the pointing interface.

50. The method of claim 37, wherein the adjusting characteristics of the interface area further comprises shifting the interface area on the display to a position adjacent to an original position of the interface area.

51. The method of claim 37, wherein the adjusting characteristics of the interface area further comprises presenting additional information on the display.

52. The method of claim 36, further comprising measuring movements of the at least one pointing element in respect to the pointing interface; and performing actions responsive to spatial relations of the measured movements of the at least one pointing element and the pointing interface.

53. The method of claim 36, further comprising measuring a size of the at least one pointing element.

54. The method of claim 36, wherein the at least one pointing element comprises a plurality of pointing elements.

55. The method of claim 36, further comprising emulating a touch upon crossing a specified virtual surface at a specified distance from the pointing interface.

56. The method of claim 36, further comprising providing non visual feedback upon specified criteria.

57. The method of claim 36, wherein the action is selected from a vibrational signal, an optical signal, and an acoustic signal.

58. The method of claim 36, further comprising detecting at least one of: an XY location, a movement, a dynamic parameter, and a duration at a location, of the at least one pointing element.

59. The method of claim 36, further comprising detecting is carried out in a specified spatial region.
